(19) United States
(12) Patent Application Publication
(10) Pub. No.: US 2021/0080777 A1
(43) Pub. Date: Mar. 18, 2021

(54) LIQUID CRYSTAL PANEL AND MANUFACTURING FOR THE SAME

(71) Applicant: Shenzhen China Star Optoelectronics Technology Co.,Ltd., Shenzhen, Guangdong (CN)

(72) Inventors: Chaode MO, Shenzhen, Guangdong (CN); Jie SUN, Shenzhen, Guangdong (CN)

(21) Appl. No.: 16/077,416

(22) PCT Filed: Apr. 25, 2018
(86) PCT No.: PCT/CN2018/084473

§ 371 Date: Aug. 10, 2018

(30) Foreign Application Priority Data
Apr. 4, 2018 (CN) 201810298173.4

(51) Int. Cl. G02F 1/1335; G02F 1/1362; G02F 1/1343; G02F 1/1339

(52) U.S. Cl. CPC G02F 1/133502; G02F 1/1362; G02F 1/13439; G02F 2001/13398; G02F 1/13394; G02F 2001/136222; G02F 2001/133565; G02F 1/133512

(57) ABSTRACT

A liquid crystal panel and a manufacturing method are disclosed. The liquid crystal panel includes a glass substrate, an array substrate disposed opposite to the glass substrate, and a liquid crystal, a reflection reducing film and a color filter disposed between the glass substrate and the array substrate, wherein, the reflection reducing film is disposed at an inner side of the glass substrate, and the color filter is disposed at an inner side of the array substrate. Through disposing a color filter at a side of the array substrate and disposing a reflection reducing film at an inner side of a substrate opposite to the array substrate, the present invention is beneficial to decrease the light reflection rate of the liquid crystal panel and improve the visual effects.

### FIELD OF THE INVENTION

The present invention relates to a liquid crystal display technology field, and more particularly to a liquid crystal panel and a manufacturing method for the same.

### BACKGROUND OF THE INVENTION

A COA (Color Filter On Array) technology is an integrated technology for fabricating a color filter layer directly on an array substrate, which can effectively solve a light leakage problem because of alignment deviation between the pixel electrode and the color resist of the color filter, and can significantly increase the aperture ratio of the display pixel and reduce the parasitic capacitance, thereby becoming a mainstream technology.

However, since this display panel does not have a filtering effect of the color filter, a white light can directly penetrate the glass and the liquid crystal to emit on the array substrate, so that reflective surfaces are formed at a cover glass, an ITO (Indium Tin Oxide) electrode at color filter substrate (CF substrate), a liquid crystal and an ITO electrode at array substrate (Array substrate). The reflective effect is increased, and the effect is particularly pronounced in the dark state, which seriously affects the visual effect. In order to reduce the reflectivity, the current countermeasure is to attach a layer of a polarizer with a lower reflectance to the outer surface of the glass, and the production cost is increased due to the high price of the polarizer.

### SUMMARY OF THE INVENTION

Due to the deficiencies in the prior art, the present invention provides a liquid crystal panel and a manufacturing method for the same, which can reduce the reflective effect of the display device, achieve low cost and beneficial to improve the visual effect.

In order to achieve the above object, the present invention adopts the following technical solutions: a liquid crystal panel, comprising: a glass substrate; an array substrate disposed opposite to the glass substrate; and a liquid crystal, a reflection reducing film and a color filter disposed between the glass substrate and the array substrate; wherein, the reflection reducing film is disposed at an inner side of the glass substrate, and the color filter is disposed at an inner side of the array substrate.

As an embodiment of the present invention, the reflection reducing film is formed at an inner surface of the glass substrate.

As an embodiment of the present invention, a transparent electrode layer and a black matrix are further provided, wherein the transparent electrode layer is disposed at a surface of the reflection reducing film away from the glass substrate, the black matrix is disposed at a surface of the transparent electrode layer away from the glass substrate and located at a non-display region of the liquid crystal panel.

As an embodiment of the present invention, multiple spacer posts are further provided, wherein one end of the spacer post is disposed on the black matrix and the other end of the spacer post is extended to abut on a side of the array substrate.

As an embodiment of the present invention, a refractive index n of the reflection reducing film satisfies: n1<n<n2, wherein n1 is a refractive index of the glass substrate and n2 is a refractive index of the transparent electrode layer.

As an embodiment of the present invention, a thickness e of the reflection reducing film satisfies:

$$e = \frac{λ}{4 n} ( 2 k + 1 ) ,$$

wherein, λ is 460 nm˜660 nm, k is a natural number.

As an embodiment of the present invention, the refractive index n of reflection reducing film satisfies: n=\sqrt{n₁n₂}.

As an embodiment of the present invention, λ=550 nm, and/or the reflection reducing film is SiOxNy, Al₂O₃, or resin.

Another purpose of the present invention provides a manufacturing method for a liquid crystal panel, comprising steps of: providing a glass substrate, and manufacturing a reflection reducing film on the glass substrate; depositing a transparent electrode layer on a surface of the reflection reducing film; using a photolithography process to manufacture a black matrix on a surface of the transparent electrode layer, wherein the black matrix is located at a non-display region of the liquid crystal panel; patterning a surface of the black matrix using a photolithography process to form a spacer post; and providing an array substrate, assembling the array substrate and the glass substrate, filling a liquid crystal between the array substrate and the glass substrate.

As an embodiment of the present invention, a thickness e of the reflection reducing film satisfies:

$$e = \frac{λ}{4 n} ( 2 k + 1 ) ,$$

wherein, n is a refractive index of the reflection reducing film, λ is 460 nm˜660 nm, k is a natural number.

In the present invention, through disposing a color filter at a side of the array substrate and disposing a reflection reducing film at an inner side of a substrate opposite to the array substrate, the present invention is beneficial to decrease the light reflection rate of the liquid crystal panel and improve the visual effects of the LCD panel.

### BRIEF DESCRIPTION OF THE DRAWINGS

FIG. 1 is a schematic diagram of a liquid crystal panel according to an embodiment of the present invention;

FIG. 2 is a schematic diagram of manufacturing principle of the liquid crystal panel according to an embodiment of the present invention; and

FIG. 3 is a manufacturing method for the liquid crystal panel according to an embodiment of the present invention.

### DETAILED DESCRIPTION OF THE PREFERRED EMBODIMENT

In order to make the purpose, the technology solution and benefits of the exemplary embodiment of the present disclosure will become clearer; the following content combines with the drawings and the embodiment for describing the present invention in detail. It can be understood that the specific embodiment described here is only used to explain the present invention, not to limit the present invention.

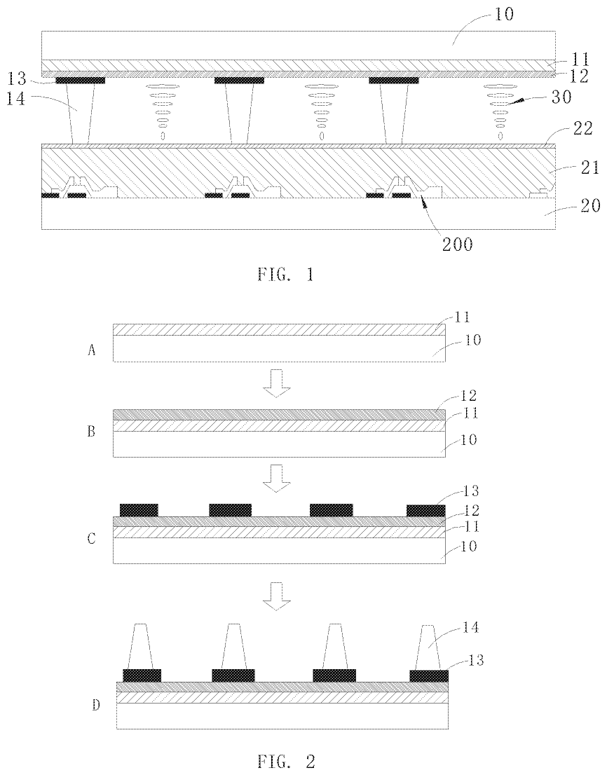

With reference to FIG. 1, the liquid crystal panel of the embodiment of the present invention includes a glass substrate 10, an array substrate 20 disposed opposite to the glass substrate 10, a liquid crystal 30, a reflection reducing film 11, and a color filter 21 disposed between the glass substrate 10 and the array substrate 20. Wherein, the reflection reducing film 11 is disposed at an inner side of the glass substrate 10, and the color filter 21 is disposed at an inner side of the array substrate 20.

Through disposing the color filter 21 at the inner side of the array substrate 20, the color filter 21 and pixel units are manufactured at a same substrate. In the alignment process of the array substrate 20 and the glass substrate 10, an alignment of the color filter 21 does not have to be considered so as to avoid a light leakage problem caused by the alignment deviation.

It can be understood that a surface of the array substrate 20 is provided with a Thin Film Transistor (TFT) 200, the color filter 21 is located between the liquid crystal 30 and the TFT 200, and a surface of the color filter 21 is provided with an electrode layer 22. Besides, alignment films located at upper and lower sides of the liquid crystal 30 are not shown in the present embodiment.

As one embodiment of the present invention, the reflection reducing film 11 is formed at an inner surface of the glass substrate 10, and can be made by SiOxNy, Al₂O₃ or a resin material in order to realize a low cost, reduce the reflection light generated by the liquid crystal panel, improve the visual effect and increase the viewing experience.

An opposite side of the array substrate 20 of the liquid crystal panel is also provided with a transparent electrode layer 12 and a black matrix 13. Wherein, the transparent electrode layer 12 is disposed at a surface of the reflection reducing film 11 away from the glass substrate 10. The black matrix 13 is disposed at a surface of the transparent electrode layer 12 away from the glass substrate 10, located at a non-display region of the liquid crystal panel, right opposite to a space between pixels. Wherein, the transparent electrode layer 12 is usually made of indium tin oxide (ITO), and the black matrix 13 can be made by a black photoresist material.

At the same time, multiple spacer posts 14 for supporting the two substrates to maintain a uniform thickness in the liquid crystal panel may also be formed on a side of the glass substrate 10. That is, one end of the spacer post 14 is disposed on the black matrix 13 and the other end of the spacer post 14 is extended to abut on a side of the array substrate 20, the spacer post 14 is located on the black matrix 13 so that the spacer post 14 does not affect a normal display of the liquid crystal panel.

A refractive index n of the reflection reducing film 11 satisfies: n1<n<n2, wherein n1 is a refractive index of the glass substrate 10, n2 is a refractive index of the transparent electrode layer 12. As one embodiment of the present application, the refractive index n of reflection reducing film 11 satisfies: n=\sqrt{n₁n₂}. A thickness e of the reflection reducing film 11 satisfies:

$$e = \frac{λ}{4 n} ( 2 k + 1 ) .$$

Wherein, λ is 460 nm˜660 nm, k is a natural number. Further, λ is referred to the 550 nm wavelength of the green light which is more sensitive to human vision. The reflection reducing film 11 is preferably to be made by SiOxNy (refractive index: 1.46˜1.92), Al₂O₃ (refractive index: 1.59˜1.77) or a resin material, which can be made by multiple films stacked together.

Through the above arrangement, when a light emits into the liquid crystal panel from an external environment, the light should sequentially pass through the glass substrate 10, the reflection reducing film 11, and the transparent electrode layer 12. The light enters an optically denser medium from an optically thinner medium in order to form a half-wave loss to reduce the energy of the reflection light, decrease the light reflection rate of the liquid crystal panel and improve the visual effects of the LCD panel.

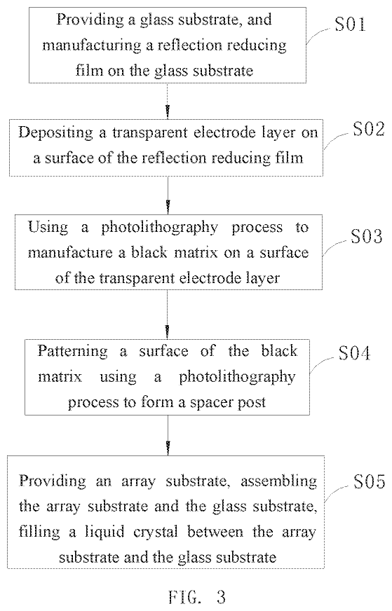

As shown in FIG. 2 and FIG. 3, the present invention also provides a manufacturing method for liquid crystal panel, including steps of:

S01: providing a glass substrate 10, and using a CVD (Chemical vapor deposition) or a PVD (Physical vapor deposition) to manufacture a reflection reducing film 11 on the glass substrate 10 (as shown in process A in FIG. 2). Wherein, the reflection reducing film 11 is made by SiOxNy, Al₂O₃ or a resin material, and a refractive index n of the reflection reducing film 11 satisfies: n1<n<n2, wherein n1 is a refractive index of the glass substrate 10, n2 is a refractive index of the transparent electrode layer 12. Furthermore, the refractive index of reflection reducing film 11 satisfies: n=\sqrt{n₁n₂}. A thickness e of the reflection reducing film 11 satisfies:

$$e = \frac{λ}{4 n} ( 2 k + 1 ) .$$

Wherein, λ is 460 nm˜660 nm, k is a natural number. Further, λ is referred to the 550 nm wavelength of the green light which is more sensitive to human vision.

S02: using a magnetron sputtering or a vapor deposition to deposit a transparent electrode layer 12 (as shown in process B in FIG. 2) on a surface of the reflection reducing film 11. Here, the transparent electrode layer 12 adopts indium tin oxide (ITO).

S03: using a photolithography process to manufacture a black matrix 13 on a surface of the transparent electrode layer 12, wherein the black matrix 13 is located at a non-display region of the liquid crystal panel (as shown in process C in FIG. 2), and the black matrix 13 is made of a black photoresist material.

S04: patterning a surface of the black matrix 13 using a photolithography process to form a spacer post 14 (as shown in process D in FIG. 2) as a color filter spacer.

S05: providing an array substrate 20, assembling the array substrate 20 and the glass substrate 10, filling a liquid crystal 30 between the array substrate 20 and the glass substrate 10. Wherein, the color filter 21 is disposed at an inner side of the array substrate 20 such that the color filter 21 and the pixel unit are manufactured on a same substrate, and a surface of the color filter 21 is also provided with an electrode layer 22.

Wherein, the black matrix 13 and the spacer post 14 can adopt a same photoresist material so that the step S03 and the step S04 can be integrated into same process, which can simplify the manufacturing process, decrease the manufacture cost, and increase the bonding strength of the spacer post 14.

In the present invention, though disposing the reflection reducing film between the glass substrate and the transparent electrode layer, a refractive index of the reflection reducing film is greater than a refractive index of the glass substrate, and less than a refractive index of the transparent electrode layer. Through using a light that enters an optically denser medium from an optically thinner medium in order to form a half-wave loss to reduce the energy of the reflection light, decrease the light reflection rate of the liquid crystal panel and improve the visual effects of the LCD panel.

The above embodiments of the present invention are only exemplary, however, the present invention is not limited. The person skilled in the art can understand: without exceeding the principle and spirit of the present invention, the above embodiments can be improved, wherein, the scope of the present invention is limited in the claims and the equivalents of the claims.

What is claimed is:

1. A liquid crystal panel, comprising:
a glass substrate;
an array substrate disposed opposite to the glass substrate; and
a liquid crystal, a reflection reducing film and a color filter disposed between the glass substrate and the array substrate;
wherein, the reflection reducing film is disposed at an inner side of the glass substrate, and the color filter is disposed at an inner side of the array substrate.

2. The liquid crystal panel according to claim 1, wherein the reflection reducing film is formed at an inner surface of the glass substrate.

3. The liquid crystal panel according to claim 2, wherein a transparent electrode layer and a black matrix are further provided, wherein the transparent electrode layer is disposed at a surface of the reflection reducing film away from the glass substrate, the black matrix is disposed at a surface of the transparent electrode layer away from the glass substrate and located at a non-display region of the liquid crystal panel.

4. The liquid crystal panel according to claim 3, wherein multiple spacer posts are further provided, wherein one end of the spacer post is disposed on the black matrix and the other end of the spacer post is extended to abut on a side of the array substrate.

5. The liquid crystal panel according to claim 3, wherein a refractive index n of the reflection reducing film satisfies: n1<n<n2, wherein n1 is a refractive index of the glass substrate and n2 is a refractive index of the transparent electrode layer.

6. The liquid crystal panel according to claim 5, wherein a thickness e of the reflection reducing film satisfies:
$$e = \frac{λ}{4 n} ( 2 k + 1 ) ,$$
wherein λ is 460 nm˜660 nm, k is a natural number.

7. The liquid crystal panel according to claim 6, wherein the refractive index n of reflection reducing film satisfies: n=\sqrt{n₁n₂}.

8. The liquid crystal panel according to claim 6, wherein λ=550 nm, and/or the reflection reducing film is SiOxNy, Al₂O₃, or resin.

9. The liquid crystal panel according to claim 4, wherein a refractive index n of the reflection reducing film satisfies: n1<n<n2, wherein n1 is a refractive index of the glass substrate and n2 is a refractive index of the transparent electrode layer.

10. The liquid crystal panel according to claim 9, wherein a thickness e of the reflection reducing film satisfies:
$$e = \frac{λ}{4 n} ( 2 k + 1 ) ,$$
wherein, λ is 460 nm˜660 nm, k is a natural number.

11. The liquid crystal panel according to claim 10, wherein the refractive index n of reflection reducing film satisfies: n=\sqrt{n₁n₂}.

12. The liquid crystal panel according to claim 10, wherein λ=550 nm, and/or the reflection reducing film is SiOxNy, Al₂O₃, or resin.

13. A manufacturing method for a liquid crystal panel, comprising steps of:
providing a glass substrate, and manufacturing a reflection reducing film on the glass substrate;
depositing a transparent electrode layer on a surface of the reflection reducing film;
using a photolithography process to manufacture a black matrix on a surface of the transparent electrode layer, wherein the black matrix is located at a non-display region of the liquid crystal panel;
patterning a surface of the black matrix using a photolithography process to form a spacer post; and
providing an array substrate, assembling the array substrate and the glass substrate, filling a liquid crystal between the array substrate and the glass substrate.

14. The manufacturing method for a liquid crystal panel according to claim 13, wherein a thickness e of the reflection reducing film satisfies:
$$e = \frac{λ}{4 n} ( 2 k + 1 ) ,$$
wherein, n is a refractive index of the reflection reducing film, λ is 460 nm˜660 nm, k is a natural number.

15. The manufacturing method for a liquid crystal panel according to claim 14, wherein the: refractive index n of reflection reducing film satisfies: n=\sqrt{n₁n₂}.

16. The manufacturing method for a liquid crystal panel according to claim 14, wherein λ=550 nm, and/or the reflection reducing film is SiOxNy, Al₂O₃, or resin.

17. The manufacturing method for a liquid crystal panel according to claim 13, wherein the black matrix and the spacer post are made by a same photoresist material, and the step of using a photolithography process to manufacture a black matrix and the step of patterning a surface of the black matrix using a photolithography process to form a spacer post are realized in a same manufacturing process.
